(19) United States
(12) Patent Application Publication
(10) Pub. No.: US 2013/0171854 A1
(43) Pub. Date: Jul. 4, 2013

(54) Waterproof Connector and Waterproof Connector Mounting Structure and Mounting Method

(71) Applicant: Hidetaka Homme, Kanagawa (JP)

(72) Inventor: Hidetaka Homme, Kanagawa (JP)

(21) Appl. No.: 13/683,441

(22) Filed: Nov. 21, 2012

(30) Foreign Application Priority Data
Nov. 28, 2011 (JP) 2011-258530

(51) Int. Cl. H01R 13/52

(52) U.S. Cl. CPC H01R 13/5202
USPC 439/272

(57) ABSTRACT

A waterproof connector is provided for ensuring an appropriate intimate contact state to a sealing member without impairing easy assembly. The connector includes a housing that holds at least one contact for establishing an electrical connection with a mating connector; and a ring-shaped sealing member mounted on the housing, the sealing member having a front face and a rear face; at least a first and a second guide portion provided adjacent to each of both faces of the sealing member, the guide portions guiding the housing when being mounted to a case.

### CROSS-REFERENCE TO RELATED APPLICATION

This application claims priority under 35 U.S.C. §119 to Japanese Patent Application No. 2011-258530, filed Nov. 28, 2011.

### FIELD OF THE INVENTION

The present invention relates to a waterproof connector provided at a place that may be exposed to water.

### BACKGROUND

Conventionally, a waterproof structure is adopted in an electrical connector to be used in an electronic device provided at a place that may be exposed to water, such as an engine room. In this waterproof connector, water is prevented from entering by using a ring-shaped sealing member to form a sealing part.

An example is disclosed in Japanese Patent Application Laid-Open No. 2009-9845 in which a connector is divided into a board connector to be assembled to a circuit board and an outer housing to be assembled to a case. The outer housing has a receiving part in which a connector housing for holding a contact of the board connector is accommodated. The case, the housings, and the board connector are assembled so that a predetermined clearance is provided between the connector housing and the receiving part of the outer housing and between the outer housing and the case. For this reason, with an assembling tolerance between the board connector and the housing and an assembling tolerance between the housing and the case, an assembling tolerance between the case and the connector can be absorbed.

Also, in Japanese Patent Application Laid-Open No. 2007-128715, a rubber-made grommet is fixed to a case cover of an electronic device to ensure a waterproof property between an electrical connector (a board connector) mounted on a circuit board on an electronic device side and the case cover.

In a waterproof connector in which a sealing member is elastically deformed to be brought into intimate contact with a sealing surface on the counterpart side, if a portion of the sealing member is compressed to a too small degree at any position on the circular sealing member, the waterproof property may not be ensured. Conversely, if a portion is deformed too strongly, the sealing member is twisted to become disengaged from a fixed position, and therefore the waterproof property may not be ensured either in this situation. Therefore, what is important for the waterproof connector to ensure the waterproof property is that the sealing member is deformed with a necessary amount to be brought into intimate contact with the sealing surface on the counterpart side, that is, to acquire an appropriate intimate contact state. However, it is not easy to assemble the waterproof connector and the case without misalignment therebetween. Moreover, the patent publications cited above do not suggest that an appropriate intimate contact state is provided to the sealing member.

### SUMMARY

Therefore, the present invention has been made in view of the above-described problems, and has an object of providing a waterproof connector capable of providing an appropriate intimate contact state to a sealing member not requiring another member, without impairing easy assembly.

A waterproof connector includes a housing that holds at least one contact for establishing an electrical connection with a mating connector; and a ring-shaped sealing member mounted on the housing, the sealing member having a front face and a rear face; at least a first and a second guide portion provided adjacent to each of both faces of the sealing member, the guide portions guiding the housing when being mounted to a case.

### BRIEF DESCRIPTION OF THE DRAWINGS

The objects, features and advantages of the invention will become more apparent by describing in detail embodiments thereof with reference to the accompanying drawings, in which:

FIG. 1 is a perspective view of a connector assembly in an embodiment;

FIGS. 2A, 2B, and 2C each show the connector assembly in the present embodiment, FIG. 2A being a plan view, FIG. 2B being a sectional view of FIG. 2A taken along line 2b-2b, and FIG. 2C being a partially enlarged view of FIG. 2B;

FIGS. 3A and 3B each show a male connector in the present embodiment, FIG. 3A being a perspective view and FIG. 3B being a sectional view of FIG. 3A taken along line 3a-3a;

FIGS. 4A and 4B each are a plan view of the male connector in the present embodiment;

FIGS. 5A and 5B each show a procedure of assembling the male connector in the present embodiment on an electronic device, FIG. 5A showing the state in which the male connector is assembled on a circuit board and FIG. 5B showing the state in which a housing cover starts to be inserted; and

FIGS. 6A and 6B each show the procedure of assembling the male connector in the present embodiment on the electronic device, FIG. 6A showing the state in which the housing cover reaches a sealing member and FIG. 5B showing the state in which the housing cover has been deeply pressed to the bottom.

### DETAILED DESCRIPTION

The present invention is described in detail below based on embodiments shown in the accompanying drawings.

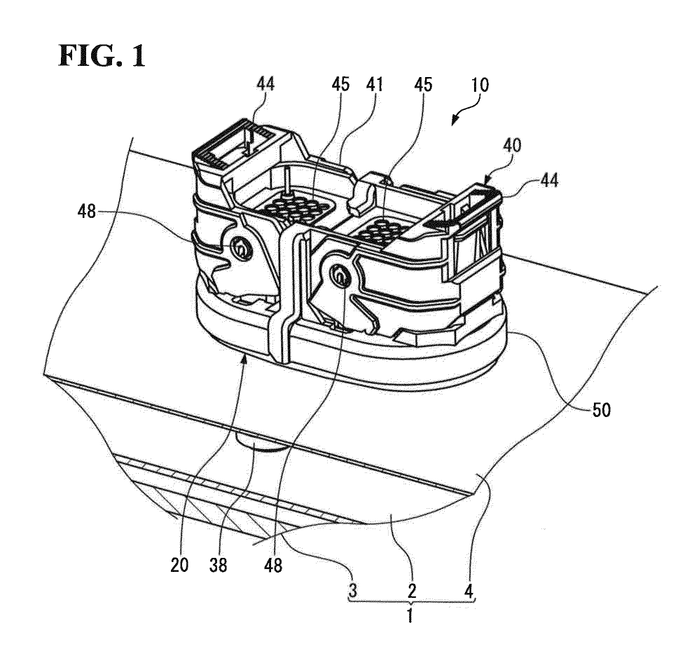

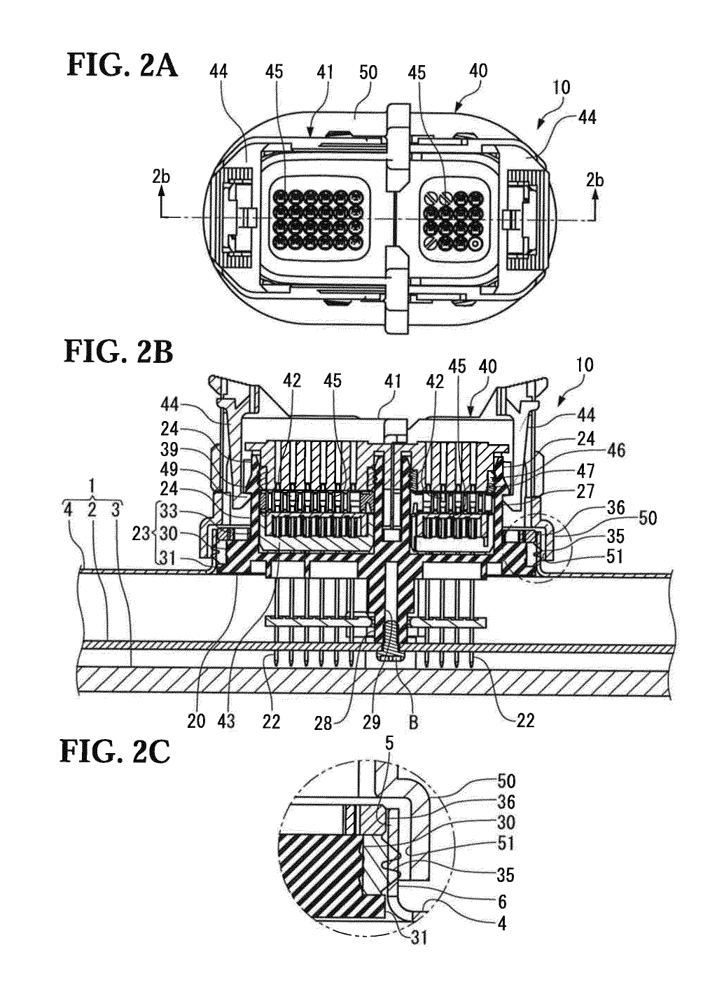

A connector assembly 10 according to an embodiment is, as shown in FIG. 1 and FIGS. 2A to 2C, a waterproof connector for use as being assembled onto an electronic device 1. The electronic device 1 has a case 3 whose outer periphery is provided with a circuit board 2, and further includes a case cover 4 made of metal covering an outer periphery of the circuit board 2. The connector assembly 10 is configured with a male connector 20 and a female connector 40 mated with each other, the male connector 20 to be electrically connected to the circuit board 2 and the mating female connector 40 serving as a counterpart connector with respect to the male connector 20. The case cover 4 has formed therein an essentially rectangular connector placement window 5 where the male connector 20 is to be placed. The male connector 20 penetrates through this connector placement window 5 to be partially accommodated in the case cover 4 for connection with the circuit board 2 placed in the case cover 4 and to be partially exposed to the outside of the case cover 4. The case cover 4 includes a flange-shaped sealing wall 6 standing from an outer periphery of the case cover 4 along the connector placement window 5. Note that various electronic elements and wiring patterns not shown are mounted on the circuit board 2.

Note that in each drawing, a sealing member 35, for instance a resilient washer or gasket which may be fabricated from elastically deformable rubber, is shown in an undeformed state for ease of understanding its shape. The same applies to a sealing member 46, which will be described further below.

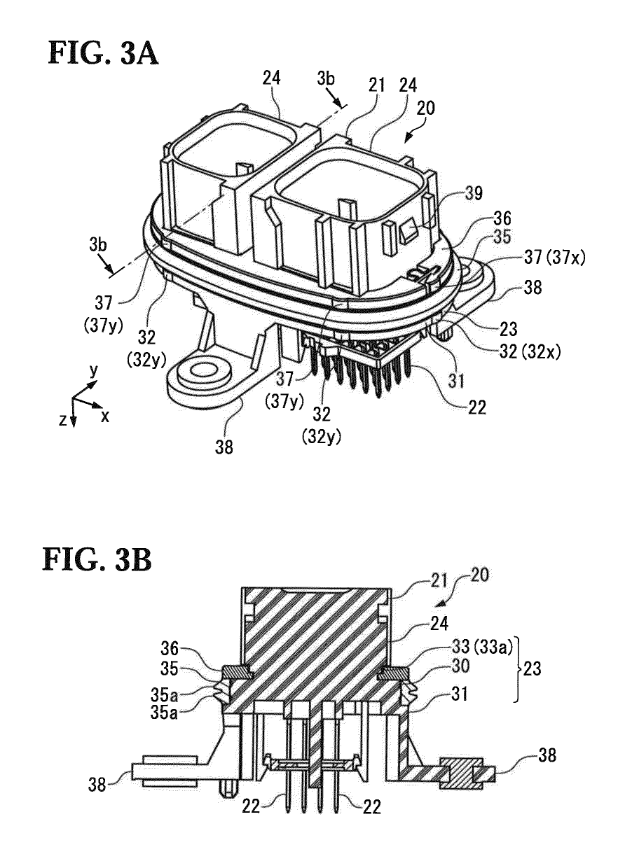

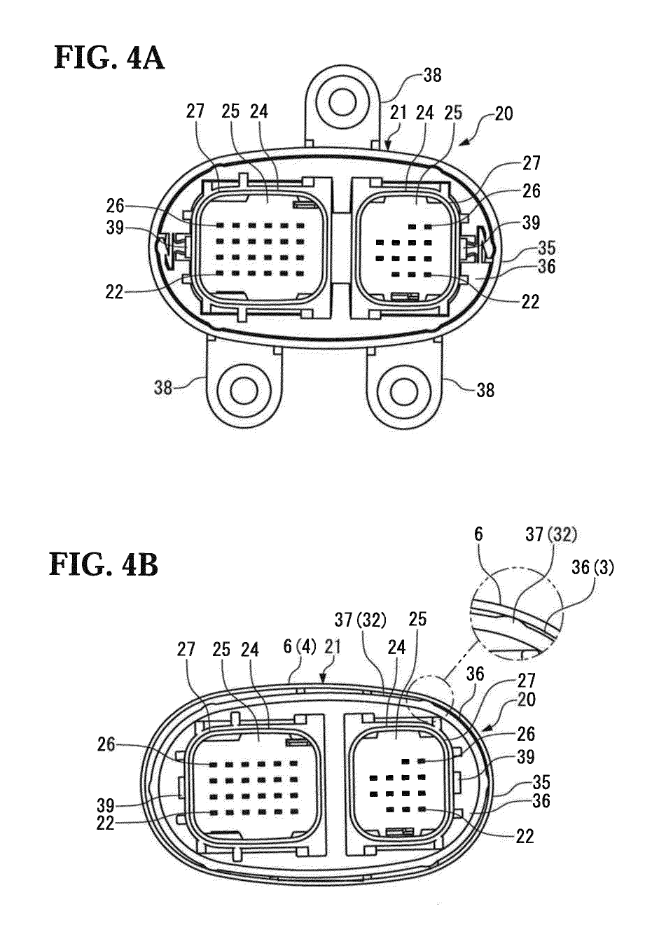

As shown in FIGS. 3A, 3B, 4A and 4B, the male connector 20, which is the waterproof connector of the present invention, includes a male housing 21 and a plurality of male contacts 22 accommodated in the male housing 21. However, the waterproof connector may of course also be a female connector, the mating connector then being a male connector. Note that in the male connector 20, a side to be connected to the counterpart female connector 40 is defined as front and a side opposite thereto and from which a wire not shown is drawn is defined as rear. The same applies to the female connector 40, a side to be connected to the counterpart male connector 20 being defined as front.

The male housing 21 is an injection-molded resin-made insulating product, and includes a base 23, two receiving parts 24 provided on a front side of the base 23, and three fixing seats 38 positioned on a rear end side of the receiving parts 24 to fix the male connector 20 to the case 3.

As shown in FIGS. 3A and 3B, the base 23 has an oval outer shape, and is formed as being extended to the outside of the receiving parts 24, which will be described further below, in a diameter direction.

The base 23 includes a seal placing part 30, a seal supporting part 31 provided on a rear side of the seal placing part 30, and a holder placing part 33 provided on a front side of the seal placing part 30, all parts along a circumferential direction. Note that, as shown in FIG. 3B, the holder placing part 33 has formed therein a holding groove 33a along a major axial direction of the base 23 to hold a tail end side of a seal holder 36.

The seal placing part 30 has a flat outer peripheral surface over the entire length in a circumferential direction, with its periphery having the sealing member 35 (e.g. fabricated from rubber) fitting in.

The seal supporting part 31 is formed with its diameter largely extended to the outside of the seal placing part 30. Therefore, when the sealing member 35 fits in the seal placing part 30, the seal supporting part 31 supports the sealing member 35 from the rear side to prevent misalignment of the sealing member 35 to the rear side. The seal supporting part 31 has an outer peripheral surface on which six guide projections 32 (first guide portions) are formed so as to be spaced apart from each other in a circumferential direction. The outer peripheral surface of the seal supporting part 31 is formed as a flat surface over the circumferential direction, except these guide projections 32.

Each of both ends of the seal supporting part 31 in a major axial direction (an x direction in FIG. 3A) is provided with one guide projection 32. These guide projections 32 are referred to as guide projections 32x. The other four projections 32 are each provided to a boundary between a large curvature portion and a small curvature portion of the seal supporting part 31. These guide projections 32 are referred to as guide projections 32y.

The guide projections 32x engage with an inner peripheral surface of the sealing wall 6 when the male connector 20 is inserted into the connector placement window 5 of the case cover 4, thereby regulating relative positions of the male connector 20 and the case cover 4 (the sealing wall 6) in a major axial direction. Similarly, the guide projections 32y engage with the inner peripheral surface of the sealing wall 6, thereby regulating relative positions of the male connector 20 and the case cover 4 (the sealing wall 6) in a minor axial direction (a y direction in FIG. 3A).

The seal holder 36 is provided on a front side of the seal supporting part 31 (the sealing member 35) of the base 23. When the sealing member 35 fits in the seal placing part 30, the seal holder 36 supports the sealing member 35 from the front side to prevent misalignment of the sealing member 35 to the front side. The seal holder 36 is fabricated separately from the male connector 20, and is provided at a predetermined position after the sealing member 35 is placed on the periphery of the seal supporting part 31.

The seal holder 36 has an outer peripheral surface on which six guide projections 37 (second guide portions) are formed so as to be spaced apart from each other in a circumferential direction. The guide projections 37 of the seal holder 36 are also provided at positions similar to those of the guide projections 32 of the seal supporting part 31. That is, each of both ends of the seal holder 36 in a major axial direction is provided with one guide projection 37. These guide projections 37 are referred to as guide projections 37x. The other four projections 37 are each provided to a boundary between a large curvature portion and a small curvature portion of the seal supporting part 31. These guide projections are referred to as guide projections 37y.

The guide projections 37x engage with an inner peripheral surface of the sealing wall 6 when the male connector 20 is inserted into the connector placement window 5 of the case cover 4, thereby regulating relative positions of the male connector 20 and the case cover 4 (the sealing wall 6) in a major axial direction. Similarly, the guide projections 37y engage with the inner peripheral surface of the sealing wall 6, thereby regulating relative positions of the male connector 20 and the case cover 4 (the sealing wall 6) in a minor axial direction.

The guide projections 37 (37x and 37y) are provided at the same positions as those of the corresponding guide projections 32 (32x and 32y) in the circumferential direction. In this manner, with the guide projections 32 and the guide projections 37 provided on both sides in a front-and-rear direction (a vertical direction in the drawings) across the sealing member 35 so as to be spaced apart from each other, relative positions of the male connector 20 and the case cover 4 (the sealing wall 6) in the front-and-rear direction (a z direction in FIG. 3A) are regulated when the male connector 20 is inserted into the connector placement window 5 of the case cover 4. Note that while an example provided herein shows that the corresponding guide projections 32 and 37 are provided at the same position in the front-and-rear direction, the present invention is not meant to be restricted to this configuration and the projections 32 and 37 can be provided as being shifted from each other.

Next, each receiving part 24 includes a holding wall 25 having holding holes 26 penetrating through the front and rear formed therein and a hood 27 standing from a circumferential edge of the holding wall 25 toward front. The contacts 22 are held by the holding wall 25 by being pressed into the holding holes 26, and each of the contacts 22 has a side on a front side of the holding wall 25 accommodated in the hood 27 and a side on a rear side of the holding wall 25 accommodated inside the case cover 4.

As shown in FIG. 2B, the holding wall 25 has a projecting part 28 projecting rearward. In this projecting part 28, a screw hole 29 opening rearward is formed. The male connector 20 is fixed via each fixing seat 38 to the case 3 with a bolt (omitted in the drawings), and is assembled to the electronic device 1 with a bolt B penetrating through the circuit board 2 being screwed into the screw hole 29 of the projecting part 28.

When the male connector 20 is assembled to the electronic device 1, the tip of the sealing member 35 of the male connector 20 is brought into intimate contact with the inner peripheral surface (a sealing surface) of the sealing wall 6 of the case cover 4 to seal a space between the case cover 4 and the male connector 20, thereby ensuring a waterproof property inside the case cover 4.

In the present embodiment, a dimension (the height) of the sealing member 35 in the front-and-rear direction is set to be smaller than the height of the sealing wall 6. This is to more reliably accommodate the sealing member 35 between the base 23 of the male connector 20 and the sealing wall 6 even if a misalignment of the case cover 4 in the front-and-rear (fitting) direction occurs. However, this is merely a preferable embodiment of the present invention.

[Female Connector 40] Next, the female connector 40 to be mated with the male connector 20 includes, as shown in FIG. 1 and FIGS. 2A to 2C, a female housing 41 corresponding to the receiving parts 24 of the male connector 20, female contacts 42 held by the female housing 41 to be electrically connected to the contacts 22 of the male connector 20, a retainer 43 for cushioning a force at the time of insertion and removal of the connector, and lever engaging parts 44 provided on the periphery of the female housing 41 to prevent disconnection between the male connector 20 and the female connector 40 mated with each other.

The female housing 41 has contact cavities 45 into which the contacts 22 of the male connector 20 are inserted. Into the contact cavities 45, electric wires not shown connected to the contacts 42 are inserted.

When the female connector 40 and the male connector 20 are connected together, the female housing 41 is accommodated in the accommodating parts 24. A holding groove 47 is provided to an entire outer periphery of the female housing 41 on a rear end. In this holding groove 47, the ring-shaped sealing member 46 is placed.

When the female connector 40 and the male connector 20 are mated with each other, the sealing member 46 is brought into intimate contact with an inner peripheral surface of the hood 27 to seal a space between the male connector 20 and the female connector 40. With such configuration, water can be prevented from entering from the space between the male connector 20 and the female connector 40.

Also, on the outer periphery of the female housing 41, unshown rotating shafts 44a of the lever engaging parts 44 are formed.

Each of the lever engaging parts 44 is rotated with a support shaft 48 formed on the outer periphery of the female housing 41 as an axis, and includes an engaging projection 49 engaging with an engaging projection 39 formed on an outer periphery of the hood 27. According to this configuration, the male connector 20 and the female connector 40 are prevented from being removed from each other.

The female housing 41 includes a skirt 50. The skirt 50 is provided on a front end side of the female housing 41, and has an accommodation space 51 (refer to FIGS. 2B and 2C) therein for accommodating a front end side of the male connector 20. When the female connector 40 is mated with the male connector 20, the base 23 of the male connector 20 is accommodated in the accommodation space 51 of the skirt 50. That is, the skirt 50 covers the seal holder 36, the sealing member 35 (the seal placing part 30), and the rubber supporting part 31. The skirt 50 also covers the sealing wall 6 of the case cover 4 configuring the sealing part together with the sealing member 35.

To achieve the function described above, the accommodation space 51 of the skirt 50 has a width set to be larger than the outer shape of the sealing wall 6. However, if a space between the sealing wall 6 and the skirt 50 is too large, the possibility of entrance of water is increased. On the other hand, if this space is too small, the skirt 50 interferes with the sealing wall 6 due to the dimensional tolerance to possibly cause a trouble in mating the female connector 40 with the male connector 20. In consideration of these points, the dimension of the width of the skirt 50 can be set. Also, a dimension (a height) of the skirt 50 in a front-and-rear direction is preferably set so that a space is formed between a front end of the female connector 40 and the case cover 4 when the female connector 40 is mated with the male connector 20. This is to secure complete mating between the female connector 40 and the male connector 20 by avoiding interference of the front end of the fitting skirt 50 with the case cover 4. As a matter of course, the height of this space, that is, the height of the skirt 50, should be determined in consideration of reduction in the possibility of entrance of water and misalignment of the connector.

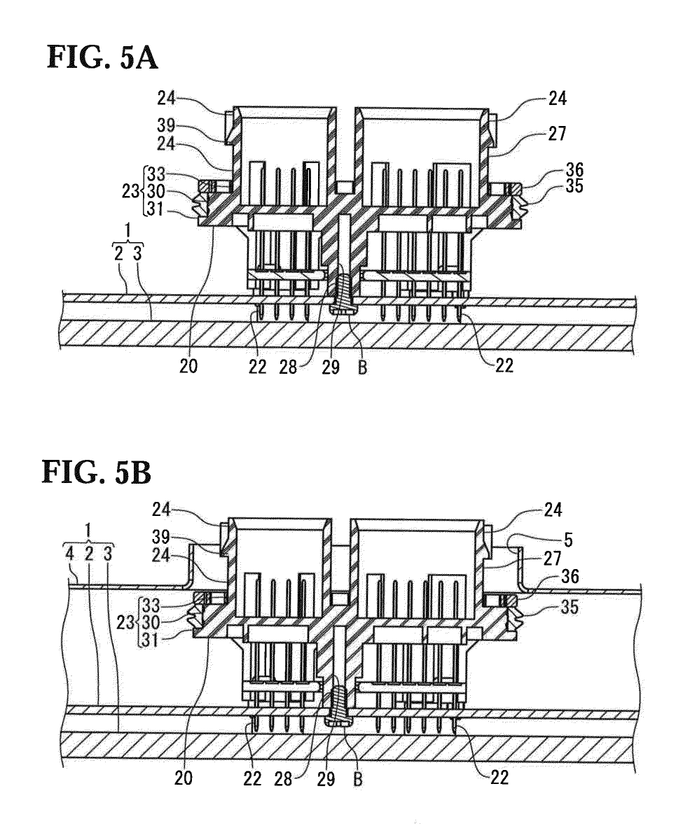

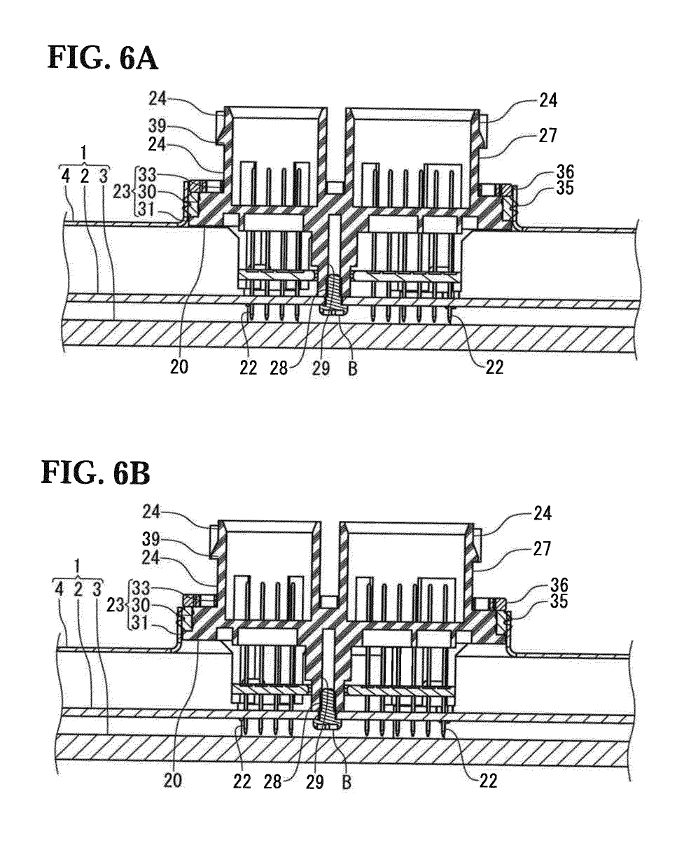

The procedure of assembling the male connector 20 to the electronic device 1 is described below with reference to FIGS. 5A, 5B, 6A, and 6B.

First, as shown in FIG. 5A, the male connector 20 is assembled to the case 3 and the circuit board 2.

This assembling is performed as described above by fixing the male connector 20 to the case 3 with bolts (not shown) via the fixing seats 38 and screwing the bolt B penetrating through the circuit board 2 into the screw hole 29 of the projecting part 28.

Next, as shown in FIG. 5B, the case cover 4 is placed.

While the male connector 20 is being positioned relative to the connector placement window 5 of the case cover 4, the case cover 4 is pressed toward the circuit board 2 to cause the male connector 20 to be inserted into the connector placement window 5. During this course, the first guide projections 32 and the second guide projections 37 help ensure an appropriate intimate contact state of the sealing member 35 of the male connector 20 between these guide projections and the sealing wall 6 of the case cover 4.

That is, when the sealing wall 6 reaches the seal holder 36, the guide projections 32 interfere with the inner periphery surface of the sealing wall 6. Thus, the case cover 4 is not misaligned with respect to the male connector 20 as the guide projections 32 go beyond interference with the sealing wall 6. For example, even if the case cover 4 is inserted into the male connector 20 as being tilted, as shown in FIG. 4B, the guide projections 37 (32) engage with the inner peripheral surface of the sealing wall 6, thereby allowing the male connector 20 to be inserted into the connector placement window 5 while regulating a further tilt of the case cover 4. Therefore, as shown in FIG. 6A, when the case cover 4 is pressed to reach the sealing member 35, the sealing member 35 is brought into intimate contact with the inner peripheral surface of the sealing wall 6 over an entire area in a circumferential direction so as to obtain an intimate contact width necessary for ensuring a waterproof property.

When the case cover 4 is further pressed, as shown in FIG. 63, the sealing wall 6 passes the sealing member 35 to reach the seal supporting part 31. As a result, the guide projections 32 provided on the periphery of the seal supporting part 31 engage with the inner peripheral surface of the sealing wall 6, thereby regulating the tilt of the case cover 4 in a manner similar to that described above. With the provision of the guide projections 32 and 37 across the sealing member 35 in a front-and-rear direction, this tilt of the case cover 4 is regulated not only in a planar direction (in an x direction and a y direction in FIG. 3A) but also in the front-and-rear direction (a z direction in FIG. 3A). In this manner, only by pressing the case cover 4 to the bottom, the necessary intimate contact width necessary for ensuring a waterproof property is provided to the sealing member 35. According to such configuration as described above, the connector assembly 10 of the present embodiment can provide a high waterproof property between the case cover 4 and the male connector 20.

If the guide projections 32 and 37 are not provided, the case cover 4 is pressed to the bottom as the case cover 4 keeps being significantly tilted in the planar direction and the front-and-rear direction. Then, a partial contact occurs in which a portion with a too large intimate contact width and a portion with a too small intimate contact width are present in a mixed manner in the sealing member 35. The portion with a too small intimate contact width has an insufficient waterproof property. In the portion with a too large intimate contact width, if the sealing member 35 and the sealing wall 6 too strongly interfere with each other, the sealing member 35 can be twisted or removed from the seal supporting part 31. This also does harm to the waterproof property.

After the case cover 4 is pressed to the bottom, the female connector 40 is caused to be mated with the male connector 20. As a result, as shown in FIG. 1, the male connector 20 is covered with the female connector 40. In particular, a portion sealed with the sealing member 35 and the sealing wall 6 is completely covered inside the skirt 50 of the female connector 40, thereby preventing water from directly coming from the outside to the sealed portion. Also, the factor responsible for damage to the waterproof property is not directly provided from the outside to the sealing member 35, thereby further improving the waterproof property of the sealed portion.

In the connector assembly 10 described above, the provision of the guide projections 32 and 37 at six positions at the periphery of the seal support part 31 and the seal holder 36, respectively, is suitable for guiding so that the center of the case cover 4 and the center of the male connector 20 match each other. However, the present invention allows the guide projections 32 and 37 to be place in a different arrangement. Even in this different arrangement, it should be assumed that the intimate contact width of the sealing member 35 be uniform in the planar direction and the front-and-rear direction. Also, a length (a dimension in the planar direction) of each of the guide projections 32 and 37 is not restrictive in the present invention. However, if the length is extremely too long, it may be difficult to ensure accuracy of a projection height over a length direction, and therefore the length is required to be set in consideration of this point.

Furthermore, the example has been described in the above embodiment in which the sealing member 35 includes two ribs 35a. This is because, even when a trouble such as a twist occurs in one rib 35a, the waterproof property can be ensured if the other rib 35a remains intact. Therefore, the sealing member 35 including a plurality of the ribs 35a is preferable.

As a matter of course, a sealing member for use in the present invention is not restricted to the one including ribs. For example, a rib sealing member or a grommet sealing member can be used.

The waterproof connector of the present invention includes the guide portions on both sides across the sealing member, the guide portion guiding the housing to a position relative to the connector placement window. In accordance with such configuration, when the housing is inserted into the connector placement window, an appropriate intimate contact state can be provided to the sealing member without performing an extra operation. Therefore, the waterproof property in the sealing part can be stably ensured.

In the waterproof connector of the present invention, the guide portions can include a first guide portion provided on one of the sides across the sealing member and a second guide portion provided on another one of the sides across the sealing member. Here, both of the first guide portion and the second guide portion can be formed integrally with the housing. Alternatively, the first guide portion can be formed integrally with the housing, and the second guide portion can be formed on a ring-shaped seal fixing member fixing the sealing member to the housing.

In the waterproof connector of the present invention, a dimension of the sealing member in a mating direction of mating with the counterpart connector is preferably smaller than a dimension of the sealing wall in the mating direction. Even if the case cover is placed in the mating direction with misalignment, the sealing member can be brought into intimate contact with the sealing wall.

In the waterproof connector of the present invention, the sealing member preferably includes a plurality of ribs projecting toward the sealing wall. This is because, even when a trouble such as a twist occurs in one rib, the waterproof property can be ensured if another rib remains intact.

In the waterproof connector of the present invention, the plurality of guide portions are preferably placed so as to be spaced apart from each other in a circumferential direction of the housing.

By freely adjusting the positions where the plurality of guide portions are to be provided, the housing can be guided to a more appropriate position of the seating wall.

In the waterproof connector of the present invention, to improve the waterproof property, the counterpart connector preferably includes a skirt, and when the counterpart connector is connected to the waterproof connector, the sealing part is covered with the skirt.

Furthermore, the present invention provides a mounting structure of a waterproof connector to be connected to a circuit board placed in a case and assembled to the case, the waterproof connector being any of the waterproof connectors described above and the case cover configuring a part of the case.

According to the mounting structure of the waterproof connector of the present invention, an appropriate intimate contact state can be provided to the sealing member, thereby allowing an excellent waterproof property to be ensured inside the case.

Still further, an embodiment of the present invention may provide a waterproof connector mounting method including the steps of connecting any of the waterproof connector described above to the circuit board and mounting the case cover including the sealing wall rising from the periphery of the connector placement window on the waterproof connector connected to the circuit board so that the waterproof connector is placed on the connector placement window.

According to the waterproof connector mounting method of the present invention, only by assembling the case cover via the connector placement window to the case having the waterproof connector and the circuit board being fixed therein, an appropriate intimate contact state can be obtained in the sealing member, and therefore the mounting operation is easy.

While the present invention has been described based on the embodiments, the structures described in the embodiments above can be selectively adopted or omitted or can be changed to another structure without deviating from the gist of the present invention.

What is claimed is:

1. A waterproof connector comprising:
a housing that holds at least one contact for establishing an electrical connection with a mating connector; and
a ring-shaped sealing member mounted on the housing, the sealing member having a front face and a rear face;
at least a first and a second guide portion provided adjacent to each of both faces of the sealing member, the guide portions guiding the housing when being mounted to a case.

2. The waterproof connector according to claim 1, wherein
the first guide portion is integrally formed on the housing,

3. The waterproof connector according to claim 1, wherein
the second guide portion is formed on a ring-shaped seal fixing member fixing the sealing member to the housing.

4. The waterproof connector according to claim 1, wherein
the sealing has a thickness extending from the front face to the rear face, wherein the connector is mounted to a sealing wall projecting from said cover, and wherein the thickness is smaller than a height of said sealing wall.

5. The waterproof connector according to claim 1, wherein
the sealing member includes at least one rib projecting from an outer peripheral surface thereof.

6. The waterproof connector according to claim 1, wherein
a plurality of first and second guide portions are placed so as to be spaced apart from each other in a circumferential direction of the housing.

7. A waterproof connector assembly, comprising:
a connector having
a housing that holds at least one contact for establishing an electrical connection with a mating connector; and
a ring-shaped sealing member mounted on the housing, the sealing member having a front face and a rear face;
at least a first and a second guide portion provided adjacent to each of both faces of the sealing member, the guide portions guiding the housing when being mounted to a case;
the mating connector, said mating connector including a skirt for covering the sealing part in a mated state of the connector and the mating connector.

8. A waterproof mounting structure comprising:
an electrical connector having
a housing that holds at least one contact for establishing an electrical connection with a mating connector; and
a ring-shaped sealing member mounted on the housing, the sealing member having a front face and a rear face;
at least a first and a second guide portion provided adjacent to each of both faces of the sealing member, the guide portions guiding the housing when being mounted to a case;
a case cover, configuring a part of said case and comprising a connector placement window including a sealing wall rising from a periphery of the connector placement window, wherein the guide portions engage with the sealing wall when the housing is inserted into the connector placement window, and
wherein said electrical connector is to be connected to a circuit board placed in said case and assembled to the case.

9. An assembly method of mounting a waterproof connector, said method comprising the steps of
providing a waterproof connector, said connector comprising:
a housing that holds at least one contact for establishing an electrical connection with a mating connector; and
a ring-shaped sealing member mounted on the housing, the sealing member having a front face and a rear face;
at least a first and a second guide portion provided adjacent to each of both faces of the sealing member, the guide portions guiding the housing when being mounted to a case;
connecting the waterproof connector to a circuit board; and
mounting the case cover on the waterproof connector connected to the circuit board so that the waterproof connector is placed within the connector placement window.
